(19) United States
(12) Patent Application Publication
(10) Pub. No.: US 2005/0201452 A1
(43) Pub. Date: Sep. 15, 2005

(54) Signal detector

(75) Inventor: Yi-Yang Chang, Taichung Hsien (TW)

Correspondence Address: John S. Egbert;Harrison & Egbert, 7th Floor, 412 Main Street, Houston, TX, 77002, US

(73) Assignee: ASIA OPTICAL Co., Inc., Taichung Hsien (TW)

(21) Appl. No.: 10/799,896

(22) Filed: Mar. 15, 2004

(51) Int. Cl. H04B 3/46

(52) U.S. Cl. 375/224

(57) ABSTRACT

This invention includes a Clock Signal Detector and a Data Signal Detector. The Clock Signal Detector is designed to utilize a combination of a signal converter, rectifying-filtering circuit, and an inverter to prevent undetected signal interruption. With which, when a Clock signal interruption occurs that causes the signal converter and rectifying-filtering circuit unable to output clock and D.C. potential signals correspondingly, the inverter outputs a high potential signal as a warning for the detected abnormality in the clock signals. Through this warning, this signal detector can effectively prevent undetected interruptions during clock signal transmission through fiber optics or other wires, and, as a result, avoid time and resource wastages. The Data Signal Detector is designed to utilize a set of devices containing a signal converter, an integral charger, and an inverter. When the data ratio of positive potential signal in data signal transmission becomes overly high, the signal converter and integral charger correspondingly output a higher ratio data signal and integral potential signal. Once the high ratio is detected, the inverter outputs a low-potential signal to signify the abnormality in data signal. During data transmission, a short circuit or other factors may cause a series of data signal to be continuously transmitted, which, in turn, causes the laser to continuously fire. Through the above-described mechanism, the signal detector is able to prevent such continuous data transmission and laser emission, and, in turn, reduce the power attenuation and malfunction to occur to the laser emitter. In summary, the main function of the signal detector is to instantly detect interruptions in clock signal or abnormal transmission in data signal, and with an interruption control circuit, the detector reacts by intercepting the emitting action of the laser.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention serves as a signal detector. It is specifically designed to instantly detect and react by outputting a driver signal to alert the user of the problem when interruptions or abnormality in clock and data signal transmission occurs. This device utilizes a clock signal detector to monitor the status of clock signal. When clock signal is interrupted, the signal converter and rectifying-filtering circuit cease to output corresponding signal and D.C. potential signal. Once this is detected, the inverter then outputs a high-potential signal to warn the user of the detected abnormality in clock signal. Another major component of this invention is the Data Signal Detector. It is designed to detect abnormality in data signal transmission. When the data ratio of the positive potential signal in the data signal transmission becomes overly high, the signal converter and integral charger output a corresponding high ratio data signal and integral potential signal. Once the output surpassed the standard level of potential, the inverter is then driven to output a low-potential signal as an alert to the user for the abnormality in data signal transmission. With this mechanism, the data transmission signal detector is able to instantly detect abnormal transmission and react by outputting a potential signal to alert the user, and, in turn, protect the data transmission facility as well as reducing time and resource wastages.

### BACKGROUND OF THE INVENTION

There are numerous types of detectors in the market for various uses, such as fire warning, anti-theft, quantity surveying, etc. Basically, these detection devices utilize temperature, pressure, or light sensors to detect variations in temperature, air pressure, and light, and then send out signals for warning.

However, currently, very few commonly seen transmission facilities are equipped with signal detection functions. Therefore, once the clock signal is interrupted during a transmission, the whole course of transmission is interrupted as well without any warning. Such interruptions often cause delays in time as well as transmission, and in turn cause wastages in valuable resources. Also, during data transmission, if a short circuit or other factors cause the system to continuously output a series of data signals, the abnormal data transmission may cause the transmission facility as well as the laser to become overly exhausted or even break down.

### BRIEF SUMMARY OF THE INVENTION

Improvements to previous technologies and new effects expected from this invention:

1. This signal detector is equipped with a clock signal detector 10, which is connected to the clock signal path in the data transmission. When clock signal-of the transmission is interrupted, the detector outputs a clock signal abnormality detection potential signal. This mechanism can effectively prevent undetected interruptions during a clock signal transmission through fiber optics or other types of wires, and in turn prevent time and resource wastages.

2. This signal detector is also equipped with a data signal detector 20, which is connected to the path of data signal in data transmission. When the data ratio of potential signal 1 from the data signal becomes overly high, the system outputs a data signal transmission abnormality detection potential signal. This mechanism can effectively prevent continuous emission of data signal during a short circuit or other system failures.

3. The main functions of the clock signal detector 10 and the data signal detector 20 are designed to instantly detect interruptions in the clock signal transmission or abnormal transmission in data signals. Coordinated with an interruption control circuit, the system is able to prevent continuous laser emission and in turn prevent the laser emitter from sever exhaustion or breakdown.

4. The clock signal detector 10, composed of a signal converter 11, a rectifying-filtering circuit 12, and an inverter 13, is capable of converting the Low-Voltage Positive Emitter Coupling Logic (LVPECL) signal into a Low-Voltage Transistor-Transistor Logic (LVTTL) signal, which is then coordinated with a D.C. potential signal outputted from the rectifying-filtering circuit and drives the inverter 13 to make an indicator for the clock signal, that is, output a clock signal transmission abnormality detection potential signal while clock input signal interrupts.

5. The data signal detector 20, composed of a signal converter 21, integral charger 22, and an inverter 23, is capable of converting the Low-Voltage Positive Emitter Coupling Logic (LVPECL) signal into a Low-Voltage Transistor-Transistor Logic (LVTTL) signal, which is then inputted into a integrator and then outputted to the inverter 23 for reactions against the overly high data ratio output of potential signal 1 in the signal transmission, that is, output a data signal transmission abnormality detection potential signal while inputted data signal is pulled high abnormally.

### BRIEF DESCRIPTION OF THE SEVERAL VIEWS OF THE DRAWINGS

FIG. 1 shows the external wiring of the invention.

FIG. 2 shows the internal wiring of the invention.

FIG. 3 shows the internal wiring of the clock signal detector—an implemented example.

FIG. 4 shows the signal conversion procedures of the clock signal detector—an implemented example.

FIG. 5 shows the internal wiring of the data signal detector—an implemented example.

FIG. 6 shows the signal conversion procedures of the data signal detector—an implemented example.

FIG. 7 shows the internal wiring of the integral charger in the data signal detector—an implemented example.

FIG. 8 shows the integral signal detection procedures in the integral charger of the data signal detector—an implemented example.

### DETAILED DESCRIPTION OF THE INVENTION

a. Technical Problems Intended to Solve

This invention is designed to instantly detect interruptions in clock signal and abnormality in data signal transmission. When the interruption or abnormality is detected, the device reacts by outputting a driver signal to alert the user. This device is effective in shortening the delays in transmission and in turn raises the efficiency in time and resource utilization.

b. Technical Means Used to Solve the Problem

This invention aims to provide a type of signal detector that detects abnormality in clock and data signal transmission. The clock signal detector utilizes a signal converter, a rectifying-filtering circuit, and an inverter to instantly detect abnormal transmission in clock signal and react by outputting a potential signal to alert the user of the detected abnormality. The clock signal detector functions when an interruption in the clock signal transmission occurs. When such situation occurs, the signal converter and rectifying-filtering circuit cease to output corresponding clock signal and D.C. potential signal. Once the interruption is detected, the inverter then outputs a high-potential signal to alert the user of the detected abnormality or to drive a interruption control circuit to cut off the power of the transmitter.

Furthermore, another major component in this invention is the data signal detector. It utilizes a signal converter, an integral charger, and an inverter to instantly detect abnormal transmission and outputs a potential signal as a warning. It functions when the input data ratio of the positive potential signal in data signal transmission becomes overly high. When this occurs, the signal converter correspondingly output a higher ratio data signal and then outputs the data signal to an integral charger to produce a higher integral potential signal. Once the output surpasses the defined potential level, the inverter then outputs a signal to alert the user of the detected abnormality in data signal transmission or to drive a interruption control circuit to cut off the power of the transmitter.

The features and the advantages of the present invention will be more readily understood upon a thoughtful deliberation of the following detailed description of the preferred embodiments of the present invention with reference to the accompanying drawings.

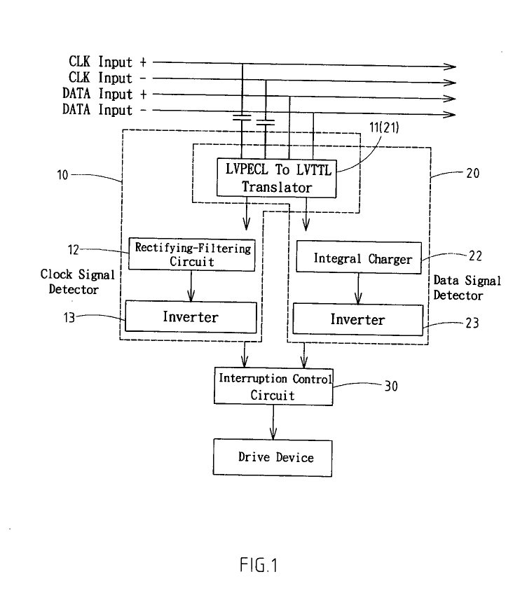

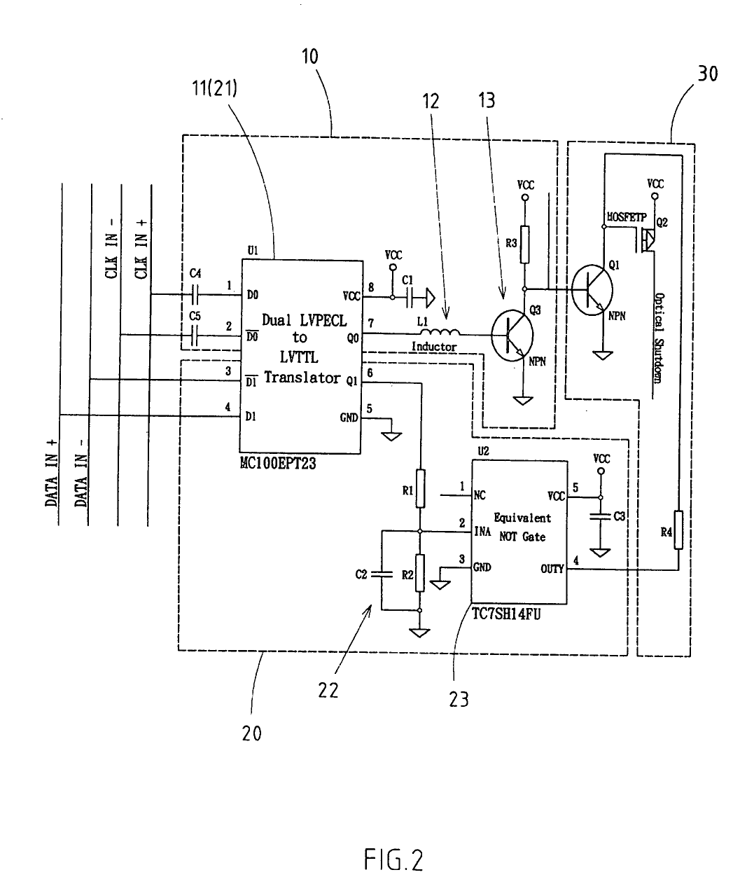

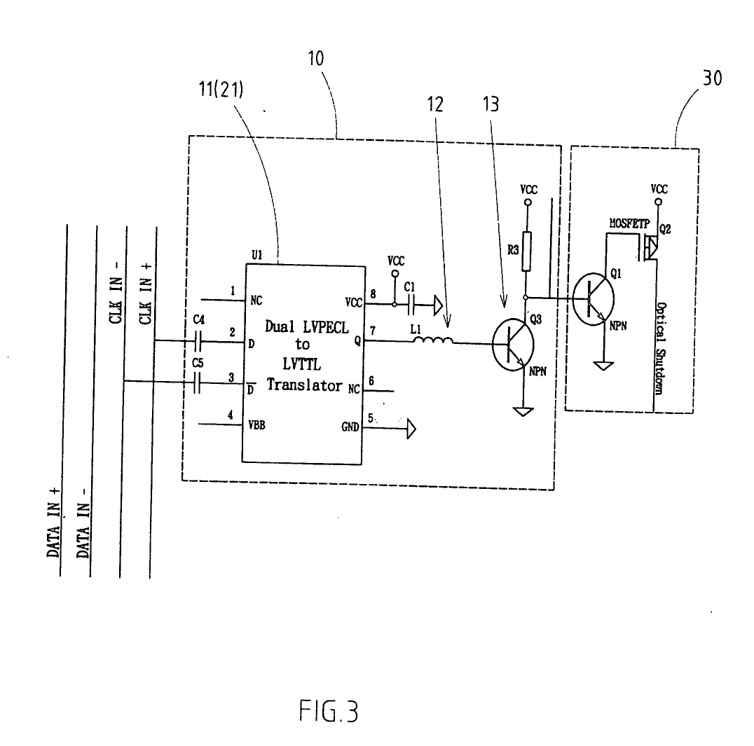

As shown in FIGS. 1 and 2, the clock signal detector 10 can be connected to the path of clock signal transmission, and the data signal detector 20 can be connected to the path of data signal transmission. The clock signal detector 10 is design with the following components: (as shown in FIGS. 2, 3, and 4)

A signal converter 11, which is the signal converter U1 between the Low-Voltage Positive Emitter Coupling Logic (LVPECL) signal input end and Low-Voltage Transistor-Transistor Logic (LVTTL) output end to convert coupled input differential clock signal into single input clock signal.

A rectifying-filtering circuit 12, which can be a stand-alone rectifying component (i.e. micro inductor L1) connected to the signal converter 11. It transforms the clock signal inputted from the signal converter into D.C. potential signal output.

An inverter 13, which is connected to the rectifying-filtering circuit 12—It serves as a buffer for Inductor LI. At the input end, the regularly present D.C. potential signal is inputted into the base of Transistor Q3, the transistor Q3 will get into the status of “ON”. Thus, the collector of the transistor Q3 regularly outputs a low potential signal. Conversely, when the clock signal disappears, in other words, no signal is inputted into the base of transistor Q3′ and the transistor Q3 will get into the status of cut-off. Thus the collector of the transistor Q3 regularly outputs a high potential signal. Base on above description, this mechanism achieves the effect of inversion, and the signal outputted is the said clock signal transmission abnormality detection potential signal, which is the resulted potential signal output, reversed from the D.C. potential signal inputted from the rectifying-filtering circuit 12.

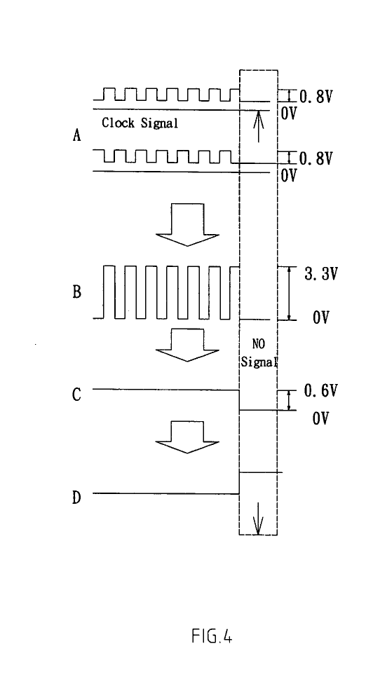

As shown in FIG. 4, the clock signal detector 10 functions when an interruption in clock signal transmission occurs. When the interruption occurs, the signal converter 11 and rectifying-filtering circuit 12 cease to correspondingly output clock signal and D.C. potential signal, which drives the inverter 13 to output a high-potential signal, that is, output a clock signal transmission abnormality detection potential signal.

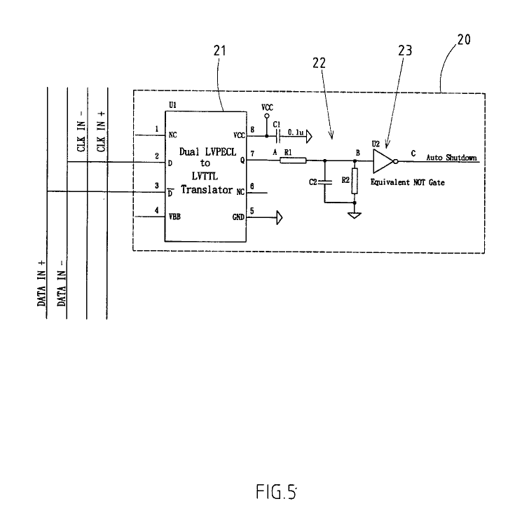

Furthermore, as shown in FIGS. 2, 5, and 6, the data signal detector 20 contains:

A signal converter 21, which acts as the Signal Converter U1 between the Low-Voltage Positive Emitter Coupling Logic (LVPECL) signal input end and the output end of a set of Low-Voltage Transistor-Transistor Logic (LVTTL) signal. This converter converts coupled input differential data signal into single output data signal.

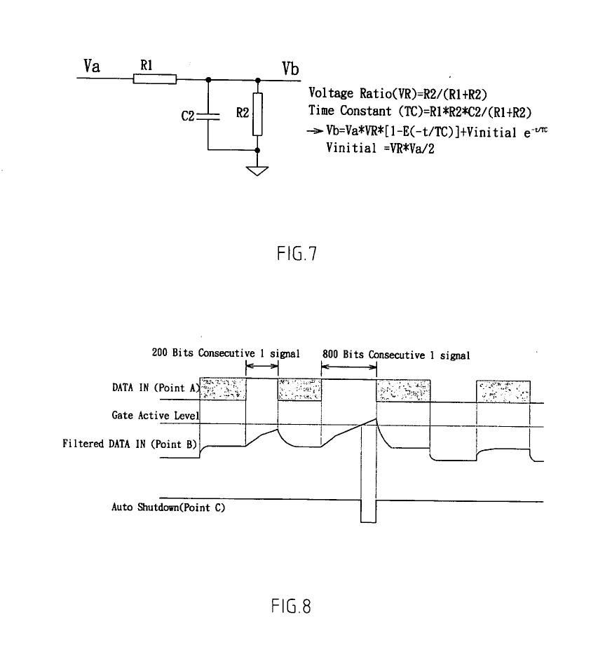

An Integral Charger 22, which is connected to the signal converter 21, as shown in FIGS. 7 and 8. The second resister R2 of the integral charger is connected to the capacitor C2 in parallel, which is then connected to the first resister R1 with a tandem connection. In which, the first resistor R1 is the input end and the tandem connection point between the first resistor R1 and the second resistor R2 is the output end. The other end of the second resistor R2 is grounded, which also converts the data signal, inputted from the signal converter 21, into a pulse type integral potential signal and outputs it to the next stage. This potential signal approximately corresponds to a constant ratio of positive potential signal pulse.

An Inverter 23, which is connected to the integral charger 22; it serves as the Logic Gate U2 and makes logic decisions to the inputted integral potential signal. It decides the status of inverting by a internal threshold voltage which is setting in logic IC. If the data ratio of positive potential signal in the differential data signal is transmitted normally, in other words, the positive potential is less than the threshold voltage, then the inverter 23 will keep the original status. Conversely, when the data ratio of positive potential signal in the differential data signal transmission becomes overly high (higher than the threshold voltage), the inverter 23 will reverse the positive signal into a low-potential signal for output. But the above statement “the low-potential signal for output” is just an example, in fact, the high or low potential of signal must lies on the requirement of next stage. Through this mechanism, reversion is achieved, and the outputted signal is the so-called data signal transmission abnormality detection potential signal, which is the potential signal output reversed from the integral potential signal inputted from the integral charger 22.

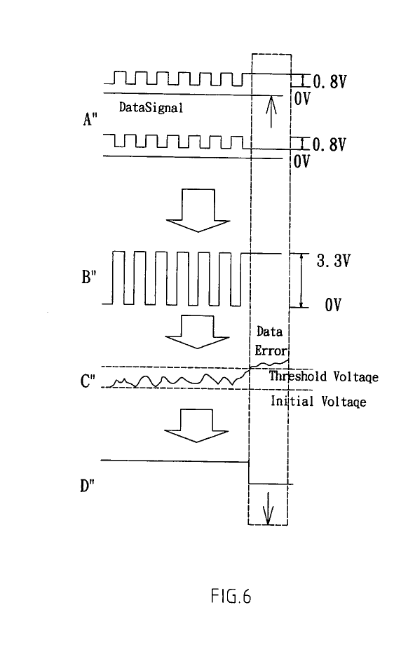

In summary, the data signal detector 20, as shown in FIGS. 6 and 8, is capable of detecting overly high ratio of potential data signal output, when the data ratio of positive potential signal in the differential data signal transmission becomes overly high, the signal converter 21 and integral charger 22 correspondingly output a higher ratio data signal and integral potential signal, and when the output surpassed the defined potential level, the inverter 23 outputs a low-potential signal, that is, the data signal transmission abnormality detection potential signal.

In which, the output end of the clock signal detector 10 and data signal detector 20, as shown in FIGS. 1 and 2, are individually connected to the interruption control circuit (30) at the emission ends of the transmission system (i.e. laser emitter of the fiber-optic transmitter end). The data signal transmission abnormality detection potential signal, in conjunction with the clock signal abnormality detection potential signal, is used to drive the interruption control circuit to stop the signals from being continuously emitted.

This interruption control circuit 30 contains a Transistor Q1 circuit. When the clock signal transmission is at a normal status, the clock signal detector 10 outputs a regularly present low D.C. potential signal into the base of the transistor Q1, which maintains the transistor Q1 in a “cut-off” state. The collector of Transistor Q1 then sends out a high D.C. potential signal to the originator of FET Transistor Q2. At this time, due to the input of high D.C. potential signal, the FET Transistor Q2 stays in a “cut-off” state—not sending out any interruption signals; therefore, the interruption control circuit 30 takes no action. The interruption control circuit only acts when the data signal detector 20 inputs a low-potential signal of data signal transmission abnormality detection into the originator of FET Transistor Q2, or when the clock signal detector 10 inputs a high-potential signal of clock signal abnormality detection into the base of Transistor Q1 to initiate the circuit between the collector and emitter of Transistor Q1. The interruption control circuit only acts to cease the operation of the emitting end of the transmission system when the originator of FET Transistor Q2 is in a “ON” state.

As shown in FIGS. 7 and 8, the potential of the integral charger 22 in the Data signal detector 20 starts to integrate upwards from the initial potential (Vinitial). The slope of upward integration is determined by the R-C time constant TC in the integral charger 22 circuit. Normal data signal output should not stay as positive potential pulse signal for a long period of time. The above-mentioned Vinitial is configured based on the assumption of a normal data transmission state. It is configured based on a voltage calculated from positive/negative spaced integration of a pulse—Va*VR/2; the threshold voltage of inverter 23 is Vt′ the integral output potential is Vb and the charge formula is Vb=Va*VR*[1−e(−t/TC)]+Vinitial e raise the power of (−t/TC). In this invention:
TC=R1*R2*C2/(R1+R2)
VR=R2/(R1+R2)
Vinitial=Va*VR/2

This integral output potential Vb approximately corresponds to a data pulse which constantly stays as a positive potential. When the data ratio of potential signal in the data pulse becomes overly high, the integral potential rises correspondingly, and when the integral output potential Vb surpasses the threshold voltage Vt, an abnormality in data transmission is indicated. Once this occurs, the detector sends out a low-potential D.C. signal through this IC Logic Gate U2 (which is the equivalent of the inverter 23). This signal is the said data signal transmission abnormality detection potential signal. If data transmission is in a normal state, the detector outputs a high-potential D.C. signal, and the above-mentioned threshold voltage serves as the determinant potential to decide whether the inverter 23 should output a reverse signal; that is, the potential must be higher then this threshold voltage for the inverter to initiate a reaction.

The clock signal detector 10 sends out a clock detection signal to the base of Transistor Q1 in the interruption control circuit 30. If the clock signal is in a normal state, this detection signal is outputted as zero potential, which maintains Transistor Q1 in an “OFF” state, and, based on the behavior of the Transistor Q2 in the interruption control circuit 30, the detector does not output a ShutDown signal to the driver device. Conversely, if the clock signal ceases to be present, Transistor Q1 is then turned to the “ON” state and outputs a ShutDown signal to the control driver device, which will then stop the signal emission.

The Data signal detector 20 outputs data detection signals to the gate of Transistor Q2 in the interruption control circuit 30. When data signal transmission is in a normal state, the detection signal is outputted in high potential; therefore, the control circuit 30 does not output a ShutDown signal to the driver device. Conversely, if abnormal data signal transmission occurs, the interruption control circuit 30 outputs a ShutDown signal to the emission end of the transmission system, which will then stop the signal emission.

1. A clock signal detector which is designed to be used in telecommunication transmission systems, said clock signal detector comprising:
a signal converter, which converts coupled input differential clock signal into single output clock signal;
a rectifying-filtering circuit connected to the signal converter and converting clock signals outputted from the signal converter into DC potential signal output; and
an inverter connected to the rectifying-filtering circuit and outputting the D.C. potential signal from the rectifying-filtering circuit as a reversed potential signal; wherein interruptions in clock signal transmission are detected such that when the interruption occurs, the signal converter and rectifying-filtering circuit cease to correspondingly output clock signal and D.C. potential signal; and wherein, once this is detected, the inverter outputs a high-potential signal, that is, a clock signal transmission abnormality detection potential signal.

2. The clock signal detector as defined in claim 1, wherein said the signal converter serves to convert Low-Voltage Positive Emitter Coupling Logic (LVPECL) signal (input end) into Low-Voltage Transistor-Transistor Logic (LVTTL) signal (output end).

3. The clock signal detector as defined in claim 1, wherein said rectifying-filtering circuit is comprised of a stand-alone rectifying component (i.e. micro inductor)

4. The clock signal detector as defined in claim 1, wherein said inverter is comprised of a transistor circuit, at an input end, the regularly present D.C. potential signal being inputted into the base of the transistor, which connects the circuit between the collector and emitter of the transistor, and, regularly outputs a low potential from the output end at the collector; and wherein, when the clock signal disappears, the circuit closes the conduction between the collector and emitter of the transistor to trigger a high-potential output from the output end at the collector of the transistor; and wherein the effect of inversion is achieved, and the signal outputted is the so-called clock signal transmission abnormality detection potential signal.

5. The clock signal detector as defined in claim 1, wherein said output end can be connected to an interruption control circuit at the emission end of a transmission system (i.e. laser emitter of the fiber-optic transmitter); and wherein a potential signal of clock signal transmission abnormality detection is used to drive the interruption control circuit to stop the signals from being continuously emitted.

6. A data signal detector which is designed to be used in telecommunication transmission systems said data signal detector comprising:
a signal converter converting coupled input differential data signal into single output data signal;
an Integral Charger connected to the signal converter and converting the data signal inputted from the signal converter into a pulse type integral potential signal outputs wherein the potential signal approximately corresponds to a constant ratio of positive potential signal pulse; and
an inverter connected to the integral charger and outputting a D.C. potential signal from the integral charger as a reversed potential signal; wherein the data signal detector is capable of detecting overly high data ratio of data signals; and wherein, when the data ratio of positive potential signal in the differential data signal transmission becomes overly high, the signal converter and integral charger correspondingly output a higher ratio data signal and integral potential signal, and when the output surpassed the defined potential level, the inverter outputs a low-potential signal, that is, the data signal transmission abnormality detection potential signal.

7. The data signal detector as defined in claim 6, the signal converter serves to convert Low-Voltage Positive Emitter Coupling Logic (LVPECL) signal (input end) into Low-Voltage Transistor-Transistor Logic (LVTTL) signal (output end).

8. The data signal detector as defined in claim 6, the second resister of the integral charger can be connected to the capacitor in parallel, which is then connected to the first resister with a tandem connection; wherein the first resistor is the input end and the tandem connection point between the first resistor and the second resistor is the output end and another end of the second resistor is grounded; and wherein threshold voltage output potential is Vb and the charge formula is Vb=Va*VR*[1−e(−t/TC)]+Vinitial e raise the power of (−t/TC), in which,
TC=R1*R2*C2/(R1+R2)
VR=R2/(R1+R2)
Vinitial=Va*VR/2

9. The data signal detector as defined in claim 6, this inverter serves as a Logic Gate and makes logic decisions to the inputted integral potential signal, enabling while input of a constant ratio of integral potential pulses and reverses the potential pulses into a high potential signal for output, wherein the data ratio of positive potential signal in the differential data signal transmission becomes overly high, hen being inputted as a higher ratio integral signal pulse and reversed into a low-potential signal for output; and wherein this mechanism, reversion is achieved, and the outputted signal is the so-called data signal transmission abnormality detection potential signal.

10. The data signal detector as defined in claim 6, the output end can be connected to an interruption control circuit at the emission end of a transmission system (i.e. laser emitter of the fiber-optic transmitter end), and wherein potential signal of data signal transmission abnormality detection is used to drive the interruption control circuit to stop the signals from being continuously emitted.

11. A signal detector, which is designed to be used in telecommunication transmission systems, said signal detector comprising:
a signal converter converting coupled input differential data signal into single output data signal;
a clock signal detector receiving converted single output clock signals; wherein, when this single output clock signal is in a normal state, the clock signal detector outputs a low-potential clock detection signal, and when this single output clock signal is interrupted, the system outputs a high-potential clock detection signal;
a data signal detector receiving converted single output data signals; wherein, when this single output data signal is in a normal state, the data signal detector outputs a low-potential data detection signal, and when this single output data signal is in an abnormal state and outputs positive potential continuously, the system outputs a high-potential data detection signal; and an interruption control circuit receiving converted clock and data signals and determining production of control signals according to the potential states of the clock and data detection signals; wherein, through the control signal, the interruption control circuit controls whether to emit transmission signals at the emission end of the transmission system.

12. The signal detector as defined in claim 11, the signal detector comprising:
a signal converter converting coupled input differential clock signal into single output clock signal;
a rectifying-filtering circuit connected to the signal converter and converting clock signals outputted from the signal converter into DC potential signal output; and
an inverter is connected to the rectifying-filtering circuit and outputting a D.C. potential signal from the rectifying-filtering circuit as a reversed potential signal; wherein the clock signal detector detects interruptions in clock signal transmission; wherein when the interruption occurs, the signal converter and rectifying-filtering circuit cease to correspondingly output clock signal and D.C. potential signal; and wherein, once detected, the inverter outputs a high-potential signal, that is, a clock signal transmission abnormality detection potential signal.

13. The signal detector as defined in claim 11, wherein the signal detector comprising:
a signal converter converting coupled input differential data signal into single output data signal;
an Integral Charge connected to the signal converter and converting the data signal inputted from the signal converter into a pulse type integral potential signal output; wherein the potential signal approximately corresponds to a constant ratio of positive potential signal pulse; and
an inverter connected to the integral charger and outputting a D.C. potential signal from the integral charger as a reversed potential signal wherein the data signal detector is capable of detecting overly high data ratio of data signal; and wherein when the data ratio of positive potential signal in the differential data signal transmission becomes overly high, the signal converter and integral charger correspondingly output a higher ratio data signal and integral potential signal, and when the output surpassed the defined potential level, the inverter outputs a low-potential signal, that is, the data signal transmission abnormality detection potential signal.

14. The signal detector as defined in claim 11, the output end of the clock signal detector and data signal detector can be individually connected to the interruption control circuit at the emission ends of the transmission system (i.e. laser emitter of the fiber-optic transmitter) and wherein the potential signal of data signal transmission abnormality detection, in conjunction with the potential signal of clock signal abnormality detection, is used to drive the interruption control circuit to stop the signals from being continuously emitted.

15. The signal detector as defined in claim 11, the potential states of clock and data detection signals, as described in the interruption control circuit section, refer to the positive potential control signals used to interrupt signal emission from the emitting end of the transmission system when an interruption in clock signal or abnormal continuous transmission of data signal occur; contrariwise, the control signal will not be produced.

16. The signal detector as defined in claim 11, wherein the second resister of the integral charger can be connected to the capacitor in parallel, which is then connected to the first resister with a tandem connection; wherein the first resistor is the input end and the tandem connection point between the first resistor and the second resistor is the output end, wherein another end of the second resistor is grounded, and wherein threshold voltage output potential is Vb and the charge formula is Vb=Va*VR*[1−e(−t/TC)]+Vinitial e raise the power of (−t/TC) in which,
TC=R1*R2*C2/(R1+R2)
VR=R2/(R1+R2)
Vinitial=Va*VR/2
